(19) United States
(12) Patent Application Publication
(10) Pub. No.: US 2015/0091698 A1
(43) Pub. Date: Apr. 2, 2015

(54) ELECTRIC VEHICLES AND METHOD FOR MANAGING ELECTRIC VEHICLES

(71) Applicant: O2Micro Inc., Santa Clara, CA (US)

(72) Inventor: Sterling Du, Shanghai (CN)

(73) Assignee: O2Micro Inc., Santa Clara, CA (US)

(21) Appl. No.: 14/140,239

(22) Filed: Dec. 24, 2013

(30) Foreign Application Priority Data
Sep. 29, 2013 (CN) 201310459903.1

(51) Int. Cl. B60R 25/20; B60R 25/10

(52) U.S. Cl. CPC B60R 25/2036; B60R 25/1001
USPC 340/5.72

(57) ABSTRACT

An electric vehicle and method for controlling an electric vehicle are disclosed. The electric vehicle includes a battery management system, a wireless communicating module, and a control module. The battery management system is configured for monitoring and managing a battery in the electric vehicle. The wireless communicating module coupled to the battery management system, is configured for establishing a wireless link with a portable device and for receiving an instruction associated with an access credential from the portable device through the wireless link. The control module coupled with the wireless communicating module, is configured for determining whether the access credential provides a right to control the electric vehicle based on the instruction received by the wireless communicating module and for controlling the electric vehicle according to the instruction from the portable device if the access credential provides the right to control the electric vehicle.

### FIELD OF THE PRESENT TEACHING

The present teaching relates generally to a field of electric vehicles. Specifically, the present teaching is directed to a method for managing electric vehicles.

### BACKGROUND

With a development of electric vehicle technology, there are higher demands for efficiently managing electric vehicles. For example, users may want to acquire the status of a battery in an electric vehicle or the location of the electric vehicle in a timely manner. In addition, an owner of rental electric vehicles may want to have better remote control of the electric vehicles which are rented out.

A conventional electric vehicle is equipped with a battery management system (BMS) to monitor status of a battery in the electric vehicle. The BMS is embedded at the rear end of the electric vehicle, while a display panel is embedded at the front end of the electric vehicle. The display panel is connected with the BMS by connecting wires. The connecting wires need to be long enough to be extended from the front end to the rear end of the electric vehicle, which not only increases cost, but also suffers from reliability issues.

In addition, a conventional electric vehicle has an anti-theft alarm system connected with a controller in the vehicle. A user can lock or unlock an electric vehicle using an associated remote controller. In case someone tries to move a locked vehicle, the alarm system is triggered to generate loud alarm through a speaker of the alarm system and send signals to the controller to block running of the engine.

However, an existing remote controller can only control the associated electric vehicle with limited accessible operations, no more than locking or unlocking the electric vehicle. Moreover, in order to manage a number of electric vehicles, a user has to manage the same number of remote controllers, which increases cost of management.

Therefore, there is a need for an electric vehicle and method for managing an electric vehicle that overcome the above drawbacks of an existing remote controller of a conventional electric vehicle.

### SUMMARY

The embodiments described herein relate to electric vehicles and methods for managing an electric vehicle.

In an embodiment, an electric vehicle is disclosed. The electric vehicle includes a battery management system, a wireless communicating module, and a control module. The battery management system is configured for monitoring and managing a battery in the electric vehicle. The wireless communicating module coupled to the battery management system, is configured for establishing a wireless link with a portable device and for receiving an instruction associated with an access credential from the portable device through the wireless link. The control module coupled with the wireless communicating module, is configured for determining whether the access credential provides a right to control the electric vehicle based on the instruction received by the wireless communicating module and for controlling the electric vehicle according to the instruction from the portable device if the access credential provides the right to control the electric vehicle.

In another embodiment, a method for managing an electric vehicle is disclosed. The method comprises establishing a wireless link between the electric vehicle and a portable device; receiving an instruction associated with an access credential from the portable device through the wireless link by the electric vehicle; determining whether the access credential provides a right to control the electric vehicle based on the instruction by the electric vehicle; and controlling the electric vehicle according to the instruction from the portable device if the access credential provides the right to control the electric vehicle.

Additional benefits and novel features will be preset forth in part in the description which follows, and in part will become apparent to those skilled in the art upon examination of the following and the accompanying drawings or may be learned by production or operation of the disclosed embodiments. The benefits of the present embodiments may be realized and attained by practice or use of various aspects of the methodologies, instrumentalities and combinations set forth in the detailed description set forth below.

### BRIEF DESCRIPTION OF THE DRAWINGS

Features and benefits of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 illustrates an exemplary block diagram of an electric vehicle, in accordance with an embodiment of the present teaching;

FIG. 2 illustrates an exemplary block diagram of an electric vehicle, in accordance with another embodiment of the present teaching;

FIG. 3 illustrates an exemplary block diagram of a control module in FIG. 2, in accordance with an embodiment of the present teaching;

FIG. 4 illustrates an exemplary block diagram of a control module in FIG. 2, in accordance with another embodiment of the present teaching;

FIG. 5 is a flowchart illustrating a method for managing an electric vehicle, in accordance with an embodiment of the present teaching; and

FIG. 6 is a flowchart illustrating a method for managing an electric vehicle, in accordance with another embodiment of the present teaching.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

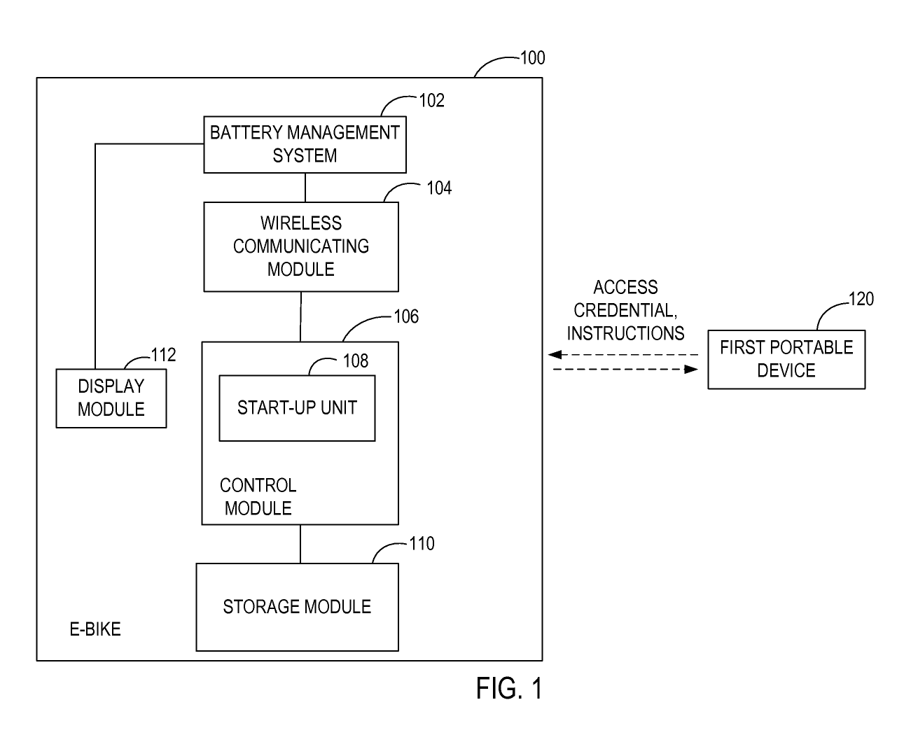

FIG. 1 illustrates an exemplary block diagram of an electric vehicle, in accordance with an embodiment of the present teaching. The electric vehicle of the present teaching may be any suitable electric vehicles, such as an electric motorcycle, an electric scooter, an electric bicycle or an electric car. The electric bike 100 will be taken as an example of the electric vehicle in FIG. 1.

The electric bike 100 includes a battery management system (BMS) 102, a wireless communicating module 104, a control module 106, a start-up unit 108, a storage module 110 and a display module 112. The electric bike 100 may be used in association with a first portable device 120. The first portable device 120 will be described in association with the electric bike 100.

The first portable device 120 may be, but not limited to a mobile phone, a tablet computer, a multimedia player, a personal digital assistant, a video game or other portable devices with a function of wireless communication.

As shown in FIG. 1, the BMS 102 is configured for monitoring and managing a battery in the electric bike 100 and determining whether any abnormality has occurred based on battery status. The battery status may include the battery voltage, remaining capacity, battery aging, and charging status such as changing current, charging voltage and charging time. The wireless communicating module 104, coupled with the BMS 102, is configured for establishing a wireless link with the first portable device 120, and for receiving one or more instructions from the first portable device 120 through the wireless link. At least one of the instructions is associated with an access credential that can provide a right to control the electric bike 100.

In one embodiment, as shown in FIG. 1, the wireless communicating module 104 is outside the BMS 102. Alternatively, the wireless communicating module 104 can be integrated inside the BMS 102. The connection between the wireless communicating module 104 and the first portable device 120 can be based on a short-range wireless protocol such as a Bluetooth, Bluetooth LE connection, or Wi-Fi connection, or based on a long-range network such as a cellular data network (e.g., a 2G/3G cellular network).

The control module 106, coupled with the wireless communicating module 104, is configured for determining whether a user of the first portable device 120 has a control right to control the electric bike 100 based on the instruction associated with the access credential received from the first portable device 120. If the control module 106 determines that the user of the first portable device 120 has the control right, the control module 106 may execute processes according to the one or more instructions from the first portable device 120.

More specifically, if the control module 106 determines that the user of the first portable device 120 has the control right to control the electric bike 100, the first portable device 120 may be allowed to send instructions to control the electric bike 100. For example, the first portable device 120 can access the BMS 102. The BMS 102 sends battery status information to the first portable device 120 through the wireless communicating module 104. After receiving the battery status information, the first portable device 120 can determine whether any abnormality has occurred based on the battery status information, or check whether the remaining capacity of the battery is enough for rest of a trip, or switch operation mode of the electric bike 100 to an energy saving mode.

In addition, the control module 106 includes a start-up unit 108. The start-up unit 108 is coupled with an alarm system (not shown in FIG. 1) installed in the electric bike 100. The start-up unit 108 is configured for determining that whether a distance between the first portable device 120 and the electric bike 100 is smaller than a predetermined distance. If the distance between the first portable device 120 and the electric bike 120 is smaller than the predetermined distance, and if the control module 106 determines that the user of the first portable device 120 has the control right to control the electric bike 100, the start-up unit 108 makes the electric bike 100 operable. In one embodiment, the start-up unit 108 determines whether the distance between the first portable device 120 and the electric bike 100 is within the predetermined distance (e.g., 30 meters) based on the communication protocol between the wireless communicating module 104 and the first portable device 120. The predetermined distance can be based on a maximum communication distance allowed for establishing a wireless connection. For example, the maximum communication distance for successfully establishing a Bluetooth connection is 30 meters. If the communication protocol between the wireless communicating module 104 and the first portable device 120 applies a Bluetooth communication protocol, the start-up unit 108 can determine that the distance between the first portable device 120 and the electric bike 100 is within 30 meters when the wireless link is established successfully.

If the first portable device 120 and the electric bike 100 establishes the wireless link successfully and the control module 106 determines that the user of the first portable device 120 has the control right, the start-up unit 108 generates a control signal to the alarm system to unlock the electric bike 100. In an embodiment, if the electric bike 100 determines that the user of the first portable device 120 has the control right to control the electric bike 100, when the user steps, again in the future, into a region which is within the predetermined distance from the electric bike 100, the electric bike 100 is unlocked automatically without any manual operations. The user can start the electric bike 100 and drive it afterwards. On the other hand, if the user steps out of the region, the wireless link between the first portable device 120 and the electric bike 100 breaks down. The electric bike 100 will be locked automatically. For example, if the communication protocol between the wireless communicating module 104 and the first portable device 120 is a Bluetooth communication protocol, and the maximum communication distance for successfully establishing a Bluetooth connection is 30 meters, whenever the user is farther than 30 meters from the electric bike 100, the electric bike 100 will be locked automatically. As a result, if the distance between the first portable device 120 and the electric bike 100 is beyond the predetermined distance, or if the control module 106 determines that the user of the first portable device 120 does not have the control right to control the electric bike 100, the electric bike 100 remains locked and cannot be operated. In this way, the first portable device 120 with the control right can act as a security key of the electric bike 100, according to the distance between the first portable device 120 and the electric bike 100.

The one or more instructions from the first portable device 120 can be any instructions that can be executed by the electric bike, such as locking, unlocking, locating or panicking an electric bike. Moreover, the first portable device 120 can transmit instructions to adjust personal setting of the electric bike, such as the speed limit settings, speed acceleration setting, keyless auto lock settings, an audio/video entertainment system setting or chair position settings.

The display module 112 is coupled to the BMS 102. The display module 112 is configured for displaying information about the electric bike 100 such as battery status information acquired by the BMS 102 and for providing an interface to implement human-computer interaction. In one embodiment, the display module 112 is coupled to the BMS 102 through wired connections. In another embodiment, the display module 112 includes a wireless unit (not shown in FIG. 1). The display module 112 can communicate with the BMS 102 wirelessly. For most electric bikes, the display module is installed in the front end of the electric bike, while other modules such as the BMS are installed at the rear end of the electric bike. If the display module includes a wireless unit, there is no need for a long wire from the front end to the rear end in the electric bike. This can avoid reliability issues caused by the wired connection, such as the loose contact or self-ignition of communicating wires.

In addition, in accordance with present teaching, a portable device can enable another portable device to control the electric bike of the present teaching. For example, an owner of a rental electric bike can rent the electric bike to another user. It will be described how the first portable device 120 enables a second portable device 220 to control an electric bike 200.

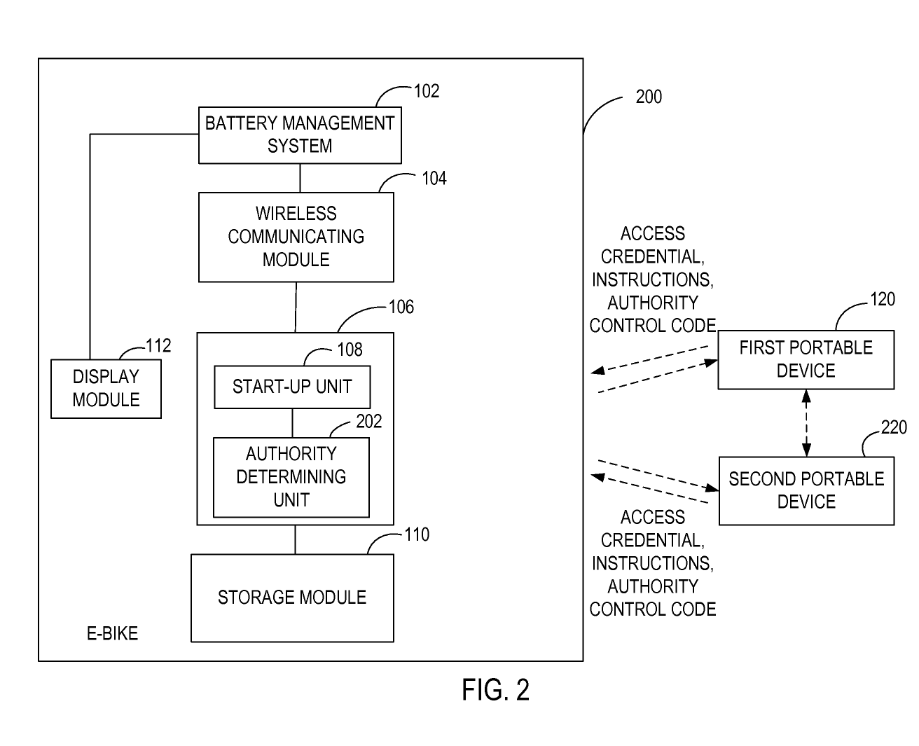

FIG. 2 illustrates an exemplary block diagram of an electric vehicle, in accordance with another embodiment of the present teaching. Elements that are labeled with the same numerals in FIG. 1 have similar functions. As shown in FIG. 2, the control module 106 in the electric bike 200 further includes an authority determining unit 202.

The second portable device 220, like the first portable device 120, can be any kind of portable device with a function of wireless communication. The first portable device 120 may transmit the access credential of the electric bike 200 to the second portable device 220 through a wireless connection (e.g., a Bluetooth or Bluetooth LE connection, a Wi-Fi connection or a cellular data network). After receiving the access credential, a user of the second portable device 220 may acquire the control right to control the electric bike 200 in a similar manner as the user of the first portable device 120. More specifically, the second portable device 220 may establish a wireless link with the electric bike 200 based on a short-range wireless protocol such as a Bluetooth or Bluetooth LE connection. Then the user of the second portable device 220 may acquire the control right by transmitting the access credential to the electric bike 200.

The first portable device 120 and the second portable device 220 can connect to the electric bike 200 at the same time. That is, two wireless channels or links can be established concurrently, one between the first portable device 120 and the electric bike 200, and the other between the second portable device 220 and the electric bike 200. Alternatively, these two wireless links can be established in sequence. For example, a connection between the first portable device 120 and the electric bike 200 can be established at first. The connection can thereafter be terminated. Later, a connection between the second portable device 220 and the electric bike 200 can be established.

In the example of FIG. 2, if the electric bike 200 determines that a current connected portable device can provide the control right to control the electric bike 200 based on the access credential received from the current connected portable device, the wireless communicating module 104 in the electric bike 200 receives an authority control code from the current connected portable device and transmits the authority control code to the control module 106. The authority determining unit 202 in the control module 106 determines the authority of the current connected portable device according to the authority control code. The current connected portable device in this example may be the first portable device 120 or the second portable device 220.

More specifically, different authority control codes correspond to different authorities. A mapping between different authority control codes and different authorities can be determined based on customers' requirements. The storage module 110 in FIG. 2 further stores a table which illustrates the relationship between the authority and the authority control code. Each portable device can be assigned with an authority control code. In one embodiment, the first portable device 120 is assigned with a highest authority. For example, the authority control code of the first portable device 120 is at a first level, which means the first portable device 120 is associated with a complete control right to control the electric bike 200. In other words, the electric bike 200 executes each and every instruction from the first portable device 120 with no exception. The second portable device 220 may be assigned with a lower authority. For example, the authority control code of the second portable device 220 is at a second level, which means the second portable device 220 is associated with a limited control right of the electric bike 200, e.g., the control right associated with the second portable device 220 is limited with respect to a particular region or time. In addition, more levels of the authority control code, such as a third level or a fourth level, can be assigned to different portable devices.

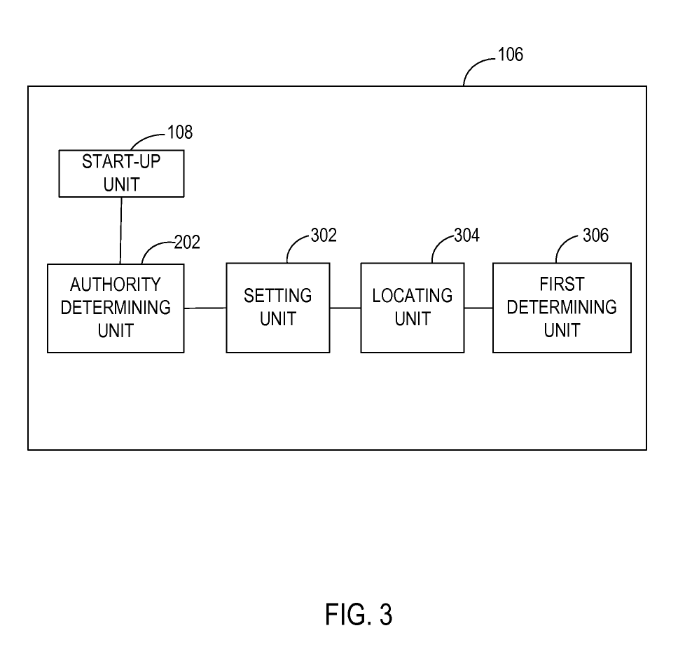

FIG. 3 illustrates an exemplary block diagram of a control module in FIG. 2, in accordance with an embodiment of the present teaching. Elements that are labeled with the same numerals in FIG. 2 have similar functions. Compared with FIG. 2, the control module 106 in the FIG. 3 further includes a setting unit 302, a locating unit 304 and a first determining unit 306. The electric bike 200 can react differently to different levels of authority control code.

The setting unit 302 is configured for configuring the electric bike 200 according to operation profiles. The operation profiles can include information with respect to the accessibility of the electric bike's operation. In one embodiment, the operation profiles include usable time and usable region according to which the electric bike 200 can be used. In other embodiments, the operation profiles may include other information according to the customers' demands, such as information for verifying users' identities.

In one embodiment, a portable device whose authority control code is at a first level can configure the operation profiles of the electric bike 200. For example, if the authority control code of the first portable device 120 is at the first level, the authority determining unit 202 can determine the authority of the first portable device 120 based on the authority control code when the first portable device 120 connects to the electric bike 200. In this case, the authority determining unit 202 determines that the first portable device 120 is associated with the authority to configure the operation profiles and transmits the determination to the setting unit 302.

The setting unit 302 then configures the operation profiles according to requirements of the user of the first portable device 120, based on the determination received from the authority determining unit 202. The user can use the first portable device 120 to configure the operation profiles of the electric bike 200 through an interface of the first portable device 120. The setting unit 302 can receive configuration information from the first portable device 120 to configure the operation profiles and transmit the configured operation profiles to the storage module 110 for storing the configured operation profiles.

In contrast, if the authority control code of the second portable device 220 is at a second level, and if the second portable device 200 connects to the electric bike 200, the authority determining unit 202 may determine that the user of the second portable device 220 does not have the authority to configure the operation profiles. The authority determining unit 202 transmits the determination to the setting unit 302. After receiving the determination, the setting unit 302 will not configure the operation profiles according to requirements of the user of the second portable device 220. Instead, the setting unit 302 retrieves the operation profiles previously stored in the storage module 110 which may have been configured based on configuration information received from the first portable device 120. Thus, the control right associated with the second portable device 220 is limited by the operation profiles configured by the user of the first portable device 120. When connected to the electric bike 200, the second portable device 220 is only associated with a limited control right that is determined by the operation profiles.

In one specific example, the authority control code of the first portable device 120 is at the first level, while the authority control code of the second portable device 220 is at the second level. In this example, if the user determines a usable region of the electric bike 200 through the first portable device 120, the setting unit 302 can receive the usable region and transmit it to the storage module 110 for storage. When the second portable device 220 connects to the electric bike 200, the setting unit 302 retrieves the predetermined usable region from the storage module 110 and activates the locating unit 304 and the first determining unit 306.

The locating unit 304 is configured for acquiring current location of the electric bike 200. In one embodiment, the locating unit 304 can be a unit that utilizes Global Position System (GPS) to obtain current position. In another embodiment, the locating unit 304 can acquire the current location of the electric bike 200 through the assistance of a portable device, e.g., the first portable device 120, the second portable device 220, or another portable device that wirelessly connects with the electric bike 200 and has a function of positioning.

In one embodiment, when arriving at a predetermined place, the locating unit 304 can send a message to the current connected portable device or other devices (e.g., a device has a function of wireless communicating). The message includes information indicating that the electric bike 200 has arrived at the predetermined place. For example, a patrol captain can set a target place in a patrolling mission of a patrol officer as the predetermined place. When the patrol officer reaches the place, the electric bike 200 will send the message to the portable device carried by the patrol officer wirelessly. The patrol officer can transmit the message to the patrol captain as an evidence of his fulfillment of his daily patrolling mission. Alternatively, the electric bike 200 can directly send the message to the portable device carried by the patrol captain. In addition, when connected to the electric bike 200, the first portable device 120 may optionally transmit an instruction to activate the locating unit 304 of the electric bike 200.

After the locating unit 304 acquires the current location of the electric bike 200, the first determining unit 306 determines that whether the current location is within the predetermined usable region. If the current location is within the predetermined usable region, the user of the first determining unit 306 allows the user who is carrying the second portable device 220 to continue controlling the electric bike 200. Otherwise, if the current location is not within the predetermined usable region, the first determining unit 306 locks the electric bike 200. For example, the first determining unit 306 can stop a moving electric bike or prevent a static electric bike from starting.

In another example, if the current location is not within the predetermined usable region, the first determining unit 306 transmits an alarm signal to the second portable device 220. In this example, the first determining unit 306 provides an extra mileage quota (e.g., 100 meters) and a new usable region for the user. The first determining unit 306 informs the user to re-schedule his/her trip within the extra mileage quota and within the new usable region, in order to prevent the electric bike from being locked.

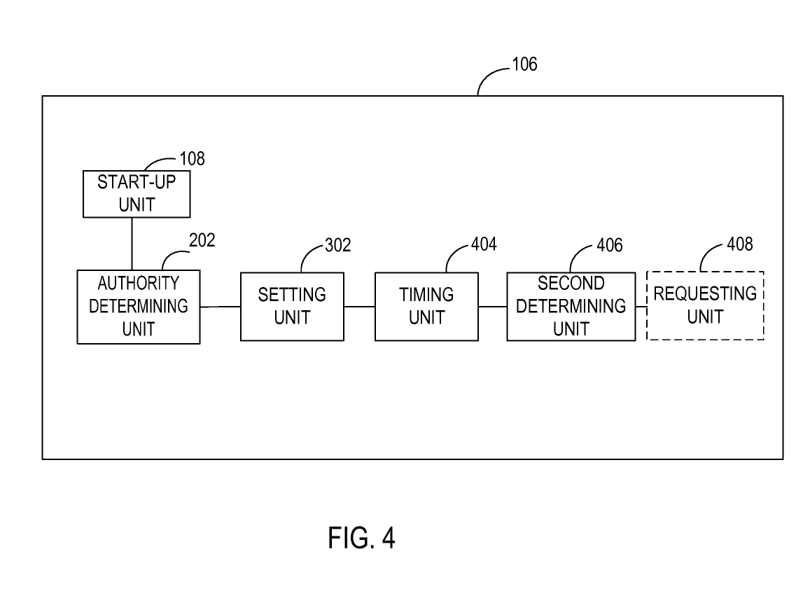

FIG. 4 illustrates an exemplary block diagram of a control module 106 in FIG. 2, in accordance with another embodiment of the present teaching. Elements that are labeled with the same numerals in FIG. 2 and FIG. 3 have similar functions. Compared with FIG. 2, the control module 106 in FIG. 4 further includes a setting unit 302, a timing unit 404 and a second determining unit 406. In addition, the control module 106 in FIG. 4 may optionally include a requesting unit 408. In one embodiment, the control module 106 in FIG. 4 may further include the locating unit 304 and the first determining unit 306 in FIG. 3.

In a specific example, the authority control code of the first portable device 120 is at the first level, while the authority control code of the second portable device 220 is at the second level. If a user predetermines a usable time of the electric bike 200 through the first portable device 120, the setting unit 302 can receive the predetermined usable time and transmit it to the storage module 110 for storage. When the second portable device 220 connects to the electric bike 200, the setting unit 302 retrieves the predetermined usable time from the storage module 110 and activates the timing unit 404 and the second determining unit 406.

The timing unit 404 is configured for calculating current operation time of the electric bike 200. The operation time of the electric bike 200 may be a time period from when the electric bike 200 is started by the second portable device 220 for the first time to current. In addition, when connected to the electric bike 200, the first portable device 120 can optionally transmit an instruction to activate the timing unit 404.

The second determining unit 406 is configured for determining whether the current operation time is beyond the predetermined usable time. If the current operation time is within the predetermined usable time, the second determining unit 406 makes it possible for the user carrying the second portable device 220 to continue controlling the electric bike 200. Otherwise, if the current operation time is beyond the predetermined usable time, the second determining unit 406 locks the electric bike 200. In another embodiment, if the current operation time is beyond the predetermined usable time, the second determining unit 406 transmits an alarming message to the second portable device 220 to indicate that the predetermined usable time is up.

In addition, as shown by the dotted rectangle in the FIG. 4, the control module 106 can optionally include the requesting unit 408. The requesting unit 408 is configured for generating request information to the second portable device 220 before (e.g., 2 hours in advance) the current operation time reaches the predetermined usable time. The request information is used to inform the user that the predetermined usable time will soon be up and ask whether the user wants to extend the predetermined usable time. If the user wants to extend the predetermined usable time, the user can use the second portable device 220 to send a request to the first portable device 120. After receiving the request, the first portable device 120 sends back an instruction of extending the predetermined usable time to the second portable device 220. Then the second portable device 220 can forward the instruction to the electric bike 200 to continue controlling the electric bike 200 after the original predetermined usable time is up. Alternatively, after receiving the request, the first portable device 120 can transmit the instruction of extending the predetermined usable time to the electric bike 200 directly.

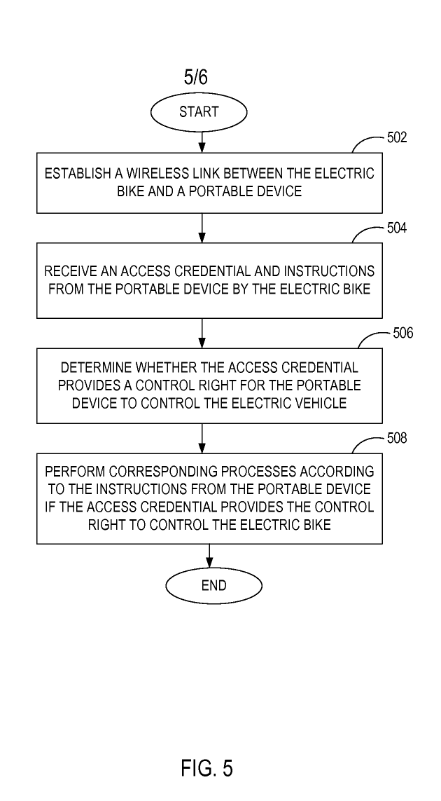

FIG. 5 is a flowchart illustrating a method 500 for managing an electric bike, in accordance with an embodiment of the present teaching.

At 502, a wireless link is established between the electric bike and a portable device. At 504, the electric bike receives an access credential and one or more instructions from the portable device through the wireless link. At 506, it is determined whether the access credential provides a control right for the portable device to control the electric bike. At 508, if the access credential provides the control right, the electric bike performs corresponding one or more processes according to the one or more instructions received from the portable device.

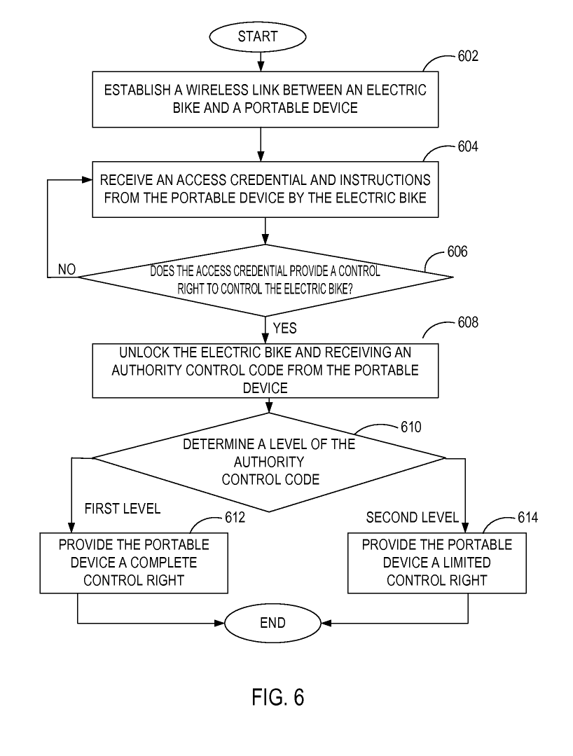

FIG. 6 is a flowchart illustrating a method 600 for managing an electric bike, in accordance with another embodiment of the present teaching.

At 602, a wireless link is established between the electric bike and a portable device. At 604, the electric bike receives an access credential and one or more instructions from the portable device through the wireless link. At 606, it is determined whether the access credential provides a control right for the portable device to control the electric bike. If the access credential provides the control right, the process goes to 608. Otherwise, if the access credential does not provide the control right, the process goes back to 604. At 608, the electric bike is unlocked automatically and receives an authority control code from the portable device. At 610, the electric bike determines a level of the authority control code. If the authority control code is at a first level, the process goes to 612. If the authority control code is at a second level, the process goes to 614.

At 612, the electric bike provides the portable device a complete control right. In one embodiment, the electric bike follows an instruction from the portable device to configure operation profiles of the electric bike and stores the configured operation profiles.

At 614, the electric bike retrieves previously stored operation profiles and provides the portable device a limited control right with the restriction according to the operation profiles.

In one specific example, if the operation profiles include a predetermined usable region, a locating unit in the electric bike detects a current location of the electric bike in real time. A first determining unit in the electric bike generates an alarm signal and informs a controller in the electric bike to lock the electric bike when the locating unit detects that the electric bike is out of the predetermined usable region.

In another specific example, if the operation profiles include a predetermined usable time, a timing unit in the electric bike calculates current operation time of the electric bike. A second determining unit in the electric bike generates an alarm signal and informs the controller to lock the electric bike when the timing unit detects the current operation time is beyond the predetermined usable time. In one embodiment, before the current operation time reaches the predetermined usable time (e.g., two hours in advance), a requesting unit in the electric bike transmits request information to the portable device for asking the user whether there is a need to extend the predetermined usable time. The electric bike then performs corresponding one or more processes according to a feedback received from the portable device.

Accordingly, the present teaching provides an electric vehicle and method for managing an electric vehicle. Users can use their own portable devices to control the electric vehicle according to the present teaching without carrying a specialized remote controller. Therefore, the method in the present teaching avoids the issue of managing multiple remote controllers in order to control multiple electric vehicles. In addition, the electric vehicle of the present teaching provides different authorities to different portable devices based on authority control codes of the portable devices. A classified control of the electric vehicles is achieved.

Those skilled in the art will recognize that the embodiments of the present teaching are amenable to a variety of modifications and/or enhancements. For example, although the implementation of various components described above may be embodied in a hardware device, it can also be implemented as a software only solution e.g., an installation on an existing server. In addition, the dynamic relation/event detector and its components as disclosed herein can be implemented as firmware, a firmware/software combination, a firmware/hardware combination, or a hardware/firmware/software combination.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. An electric vehicle comprising:
a battery management system configured for monitoring and managing a battery in the electric vehicle;
a wireless communicating module, coupled to the battery management system and configured for
establishing a wireless link with a portable device, and
receiving an instruction associated with an access credential from the portable device through the wireless link; and
a control module coupled with the wireless communicating module and configured for
determining whether the access credential provides a right to control the electric vehicle based on the instruction received by the wireless communicating module, and
controlling the electric vehicle according to the instruction from the portable device if the access credential provides the right to control the electric vehicle.

2. The electric vehicle of claim 1, wherein
the wireless communicating module is configured for receiving an authority control code from the portable device through the wireless link;
the control module comprises an authority determining unit configured for determining an authority of the portable device based on the authority control code; and
the authority indicates whether a user of the portable device has a right to configure operation profiles of the electric vehicle.

3. The electric vehicle of claim 2, wherein
the control module further comprises a setting unit coupled with the authority determining unit; and
if the user of the portable device has the right to configure the operation profiles of the electric vehicle, the setting unit is configured for receiving, from the portable device, configuration information input by the user and configuring the electric vehicle based on the configuration information.

4. The electric vehicle of claim 3, wherein the control module comprises:
a locating unit coupled to the setting unit and configured for acquiring a current location of the electric vehicle; and
a first determining unit coupled to the locating unit and configured for determining whether the current location of the electric vehicle is beyond a predetermined usable region,
wherein the setting unit activates the first determining unit if the operation profiles comprise the predetermined usable region.

5. The electric vehicle of claim 3, wherein the control module further comprises:
a timing unit coupled to the setting unit and configured for calculating operation time of the electric vehicle; and
a second determining unit coupled to the timing unit and configured for determining whether the operation time of the electric vehicle is beyond a predetermined usable time,
wherein the setting unit activates the second determining unit if the operation profiles comprise the predetermined usable time.

6. The electric vehicle of claim 5, wherein the control module further comprises:
a requesting unit coupled to the second determining unit and configured for sending a request for information regarding whether the user wants to extend the predetermined usable time of the electric vehicle before the current operation time reaches the predetermined usable time.

7. The electric vehicle of claim 1, wherein the control module comprises:
a start-up unit configured for determining a distance between the portable device and the electric vehicle and allowing the electric vehicle to be operated if the distance between the portable device and the electric vehicle is within a predetermined distance and if the access credential provides the right to control the electric vehicle.

8. The electric vehicle of claim 7, wherein
the start-up unit is configured for detecting a communication protocol between the portable device and the electric vehicle; and
the start-up unit determines that the distance between the portable device and the electric vehicle is within the predetermined distance if the wireless communicating module establishes the wireless link with the portable device successfully.

9. The electric vehicle of claim 7, wherein
the control module further comprises a locating unit coupled with the start-up unit and configured for acquiring a current location of the electric vehicle; and
the start-up unit receives information indicating the current location of the electric vehicle from the locating unit and a current location of the portable device, and determines whether the distance between the portable device and the vehicle is within the predetermined distance.

10. The electric vehicle of claim 1, wherein if the access credential provides the right to control the vehicle device, the battery management system transmits information about the status of the battery to the portable device through the wireless link.

11. The electric vehicle of claim 1, further comprising a display module configured for displaying status of the battery obtained by the battery management system, wherein the display module comprises a wireless unit for communicating with the battery management system.

12. A method for managing an electric vehicle, comprising:
establishing a wireless link between the electric vehicle and a portable device;
receiving, by the electric vehicle, an instruction associated with an access credential from the portable device through the wireless link;
determining, by the electric vehicle, whether the access credential provides a right to control the electric vehicle based on the instruction; and
controlling the electric vehicle according to the instruction from the portable device if the access credential provides the right to control the electric vehicle.

13. The method of claim 12, further comprising:
receiving an authority control code from the portable device by the electric vehicle if the access credential provides the right to control the electric vehicle; and
determining an authority of the portable device, wherein the authority indicates whether a user of the portable device has a right to configure operation profiles of the electric vehicle.

14. The method of claim 13, further comprising:
receiving information regarding configuring operation profiles from the portable device if the user of the portable device has the right to configure operation profiles of the electric vehicle;
configuring the operation profiles based on the information; and
storing the configured operation profiles.

15. The method of claim 13, further comprising:
retrieving operation profiles previously stored in the electric vehicle if the user of the portable device does not have the right to configure operation profiles of the electric vehicle.

16. The method of claim 13, further comprising:
acquiring current location of the electric vehicle and determining whether the current location is within a predetermined usable region if the user of the portable device does not have the right to configure operation profiles of the electric vehicle and if operation profiles previously stored in the electric vehicle comprise the predetermined usable region.

17. The method of claim 16, further comprising:
locking the electric vehicle if the current location of the electric vehicle is out of the predetermined usable region.

18. The method of claim 13, further comprising:
calculating current operation time of the electric vehicle and determining whether the current operation time of the electric vehicle is beyond a predetermined usable time if the user of the portable device does not have the right to configure operation profiles of the electric vehicle and if the operation profiles previously stored in the electric vehicle comprise predetermined usable time.

19. The method of claim 18, further comprising:
locking the electric vehicle if the current operation time of the electric vehicle is beyond the predetermined usable time.

20. The method of claim 18, further comprising:
sending a request to the portable device regarding whether the user wants to extend the predetermined usable time before the current operation time of the electric vehicle reaches the predetermined usable time.

21. The method of claim 12, further comprising:
detecting a distance between the portable device and the electric vehicle; and
unlocking the electric vehicle if the distance between the portable device and the electric vehicle is within a predetermined distance.
